(19) United States
(12) Patent Application Publication
(10) Pub. No.: US 2006/0017258 A1
(43) Pub. Date: Jan. 26, 2006

(54) Method and assembly for moving a trailer assembly between elevated and lowered positions

(75) Inventor: Donald Hunley, Howell, MI (US)

Correspondence Address: CLARK HILL, P.C., 500 WOODWARD AVENUE, SUITE 3500, DETROIT, MI, 48226, US

(73) Assignee: Mobility Resource Associates, Inc., Taylor, MI (US)

(21) Appl. No.: 11/185,667

(22) Filed: Jul. 20, 2005

Related U.S. Application Data
(60) Provisional application No. 60/589,501, filed on Jul. 20, 2004.

(51) Int. Cl. B62D 53/06

(52) U.S. Cl. 280/423.1

(57) ABSTRACT

A trailer assembly includes a base extending between a front end and a back end. The trailer assembly also includes a primary enclosure extending upwardly from the base to define a primary interior space. An axle/suspension carriage is secured to the back end of the base. The trailer assembly also includes a forward stand assembly fixedly secured to the front end of the base. The forward stand assembly is movable between a stowed position and a support position. In the stowed position, the forward stand assembly is disposed adjacent the primary enclosure with the base positioned away from the ground. In the support position, the base disposed adjacent to the ground and the forward stand assembly is extended out and away from the primary enclosure perpendicular to sidewalls of the primary enclosure.

### BACKGROUND ART

1. Field of the Invention

The invention relates to trailer assemblies. More specifically, the invention relates to an assembly and method for moving a trailer assembly between an elevated position and a lowered position as well as raising the roof section to increase the passenger compartment height.

2. Description of the Related Art

Typically, trailers are used to transport items to a desired location. Many times, trailers are also used as structures designed to be inhabited for a particular purpose. The environments found within these trailers can be full of equipment to facilitate a particular operation. By way of example, an environment for a trailer may be used as a classroom, an office, a conference center, a health system/counseling center, a mobile command center, and the like. It should be appreciated by those skilled in the art that any type of function that is performed within an enclosed space may be performed within a trailer environment.

To make a trailer more versatile, a trailer may be designed to expand to a greater volume once the trailer has been moved into the desired location for the operation. The same trailer is also collapsible into a smaller volume allowing it to be transported using the road system. Typically, a secondary volume that is smaller than a primary volume of space extends between a collapsed position and an expanded position. This allows a trailer of normal dimensions to be transported to a remote location and then expanded thereat to enhance the functionality of the trailer.

Another enhancement to the functionality of a trailer is the ability to retract the front and rear axle/suspension carriages. U.S. Pat. No. 3,207,527 discloses a mobile unit having this functionality. The mobile unit has a chassis member that includes a central longitudinally extending rectangular torque tube that extends the length of the mobile unit. Hydraulic jacks move the torque tube with respect to the mobile unit to raise and lower the front and rear axle/suspension carriages. A disadvantage of this type of mobile unit is the front axle/suspension carriage interferes with a truck to which the mobile unit may need to be hitched for movement.

### SUMMARY OF THE INVENTION

A trailer assembly includes a base extending between a front end and a back end. The trailer assembly also includes a primary enclosure extending upwardly from the base to define a primary interior space. An axle/suspension carriage is secured to the back end of the base. The trailer assembly also includes a forward stand assembly fixedly secured to the front end of the base. The forward stand assembly is movable between a stowed position and a support position. In the stowed position, the forward stand assembly is disposed adjacent the primary enclosure with the base positioned away from the ground. In the support position, the base disposed adjacent to the ground and the forward stand assembly is extended out and away from the primary enclosure perpendicular to sidewalls of the primary enclosure.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a side view of one embodiment of the invention with a forward stand assembly in an extended position and the roof in a lowered position;

FIG. 2 is a side view of the invention with the forward stand assembly in a retracted position along with the roof extended upwardly;

FIG. 3 is a top view of one embodiment of the invention with a secondary enclosure in an expanded position;

FIG. 4 is a cross-sectional view of the invention with the forward stand assembly in the retracted position and the roof in a raised position;

FIG. 5 is a cross-sectional view of the invention with the forward stand assembly in the retracted position, the roof in the raised position, and expanded walls roof section raised crating the primary interior;

FIG. 6 is a front view of the invention with the forward stand assembly in the extended position;

FIG. 7 is a side view of the invention with the axle/suspension carriage in the extended position prior to be loaded in an airplane cargo hold;

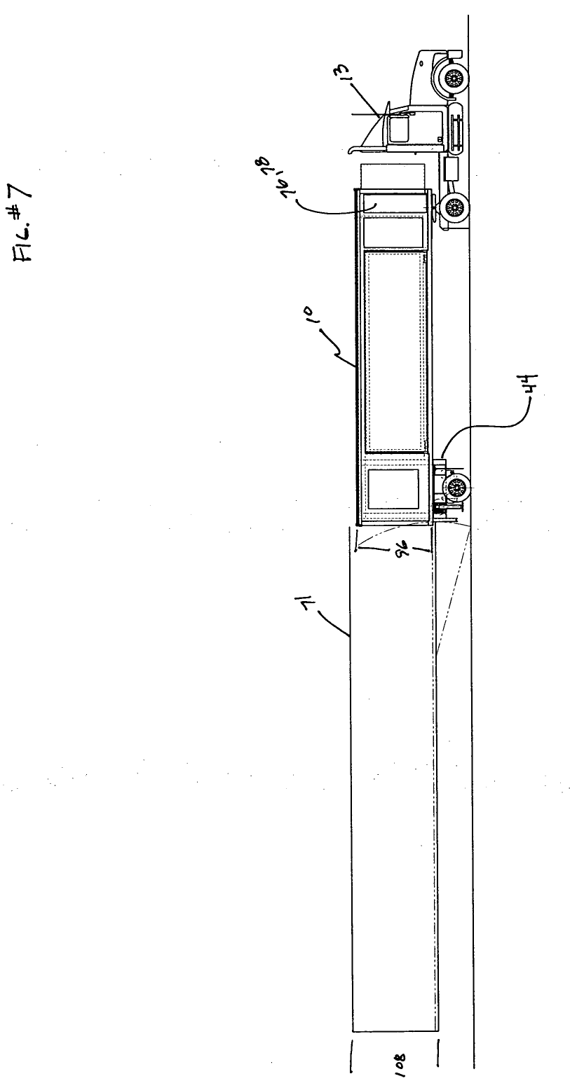

FIG. 8 is a side view of the invention with the axle/suspension carriage in the retracted position and the trailer assembly coupled to the mode of transportation;

FIG. 9 is a side view of the invention in an intermediate load position and the axle/suspension carriage in the retracted position;

FIG. 10 is a side view of the invention in the intermediate load position and the tractor removed from the trailer; and

FIG. 11 is a side view of the invention with the final load position inside the airplane cargo hold.

### DETAILED DESCRIPTION OF THE PREFERRED EMBODIMENT

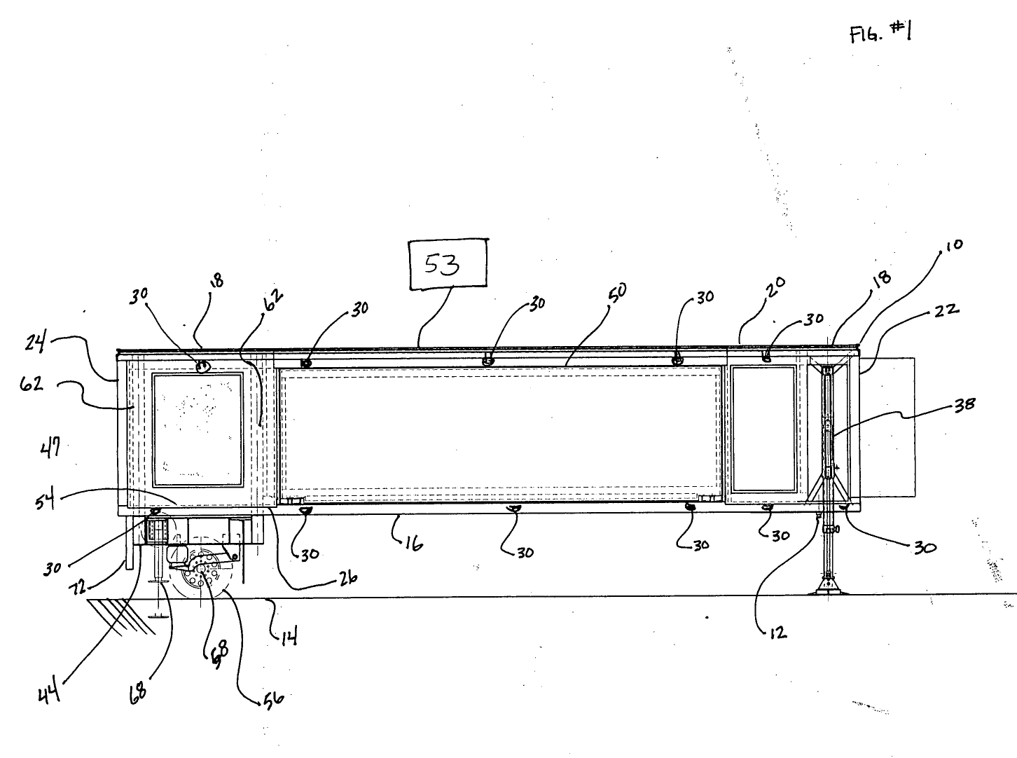

Referring to FIGS. 1 through 3, a trailer assembly is generally indicated at 10. While the trailer assembly 10 may be any general size, the trailer assembly 10 shown in the Figures is typically referred to as a “semi trailer.” The trailer assembly 10 includes a king pin 12 that allows the trailer assembly 10 to be coupled to a mode of transport, such as a truck 13 or a tractor, for travel along a road system or other transport surface 14.

The trailer assembly 10 defines a base 16. A primary enclosure, generally indicated at 18, extends upwardly from the base 16. The primary enclosure 18 includes a roof 20, a front wall 22, a rear wall 24, and a pair of sidewalls 26, 28 each extending between the front 22 and rear 24 walls. A plurality of D-rings or tie downs 30 are fixedly secured along the base 16 and the roof 20 for securing a load thereto. The trailer assembly 10 also includes anchors 31 capable of securing a lifting harness 33 thereto so a crane could lift the trailer assembly 10 into a freighter or ship.

The primary enclosure 18 defines a primary interior space 32. It is within the primary interior space 32 that a majority of the space and the equipment stored by the trailer assembly 10 are located. The primary enclosure 18 is expandable in two dimensions, the expandability of which is discussed in greater detail subsequently.

The primary enclosure 18 also includes a front interior partition 34, which along with the front wall 22 and the pair of sidewalls 26, 28 defines a forward compartment 36. The forward compartment 36 houses a forward stand assembly, generally indicated at 38 and described in greater detail below.

A computer workstation 37 is disposed adjacent the front interior partition 34 opposite the forward compartment 36. It will be appreciated that although a computer workstation 37 is shown, any of a number of items could be placed adjacent the front interior partition 34 to fulfill the particular needs of each trailer assembly owner.

In addition, the primary enclosure 18 includes a rear interior partition 40 that cooperates with the rear wall 24 and the pair of sidewalls 26, 28 to define a rearward compartment 42. The rearward compartment 42 houses an axle/suspension carriage, generally indicated at 44, a generator (not shown), and a cable power reel 48. The generator is housed behind a generator housing grill 47. A nose box 46 is secured to the front wall 22 of the trailer assembly 10. The nose box 46 may house a generator or any other equipment that may be required to accomplish the mission for which the trailer assembly 10 is deployed.

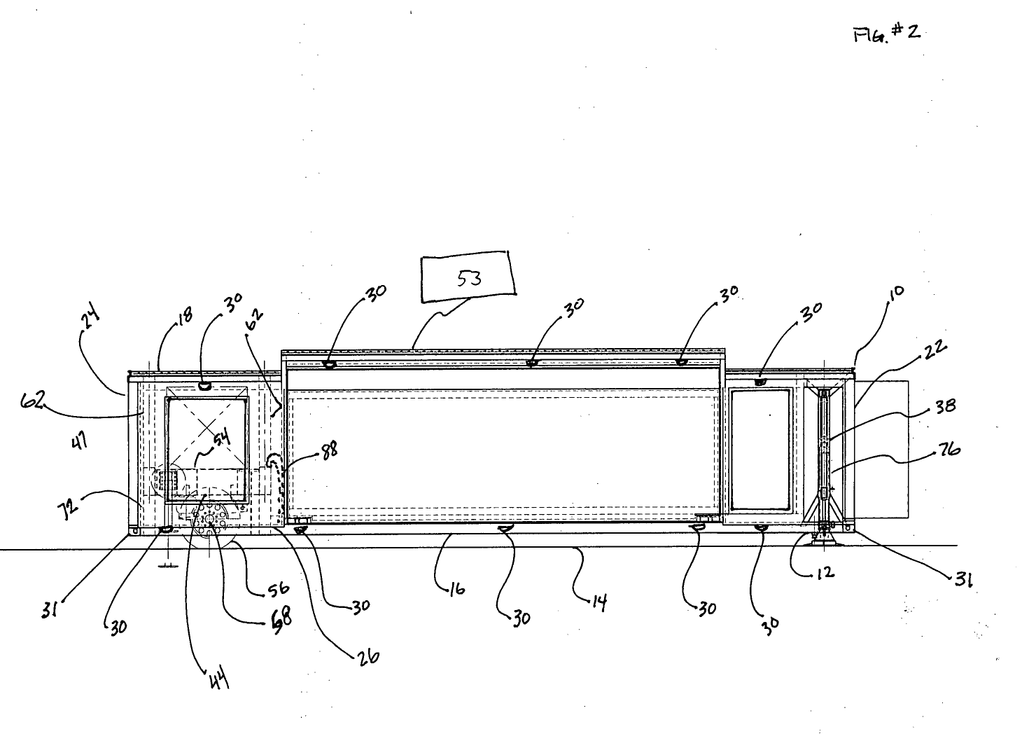

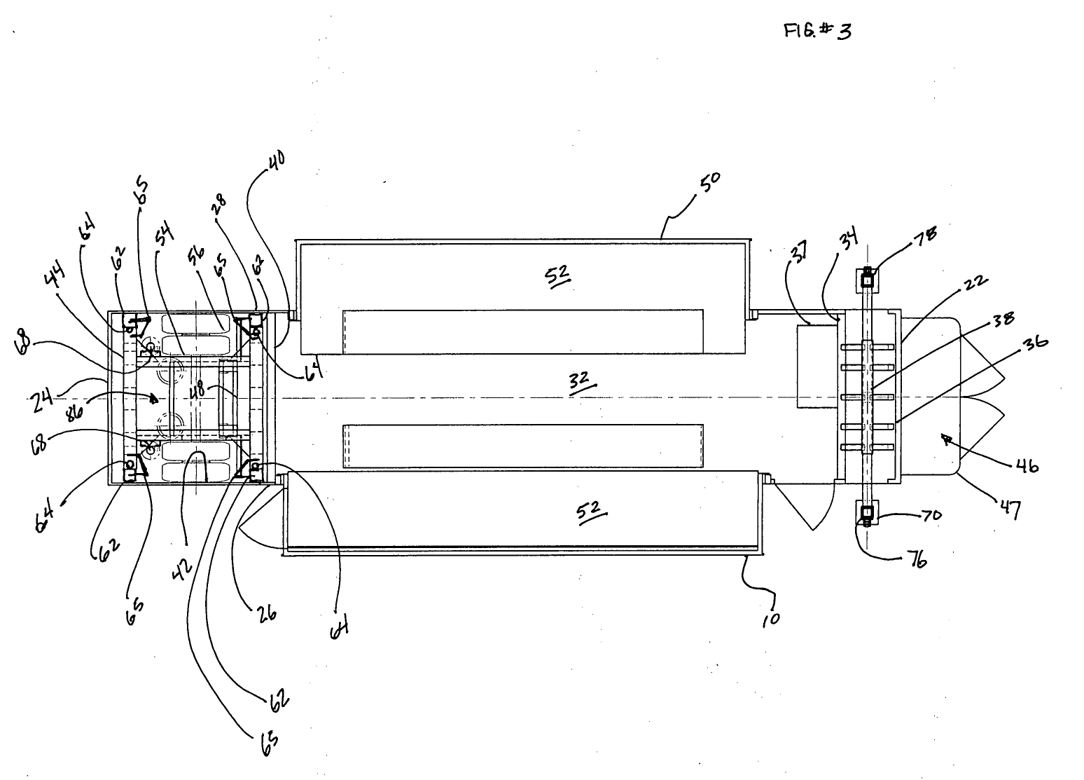

The trailer assembly 10 also includes a secondary enclosure, generally shown at 50. The secondary enclosure 50 defines a secondary interior space 52, which is smaller than the primary interior space 32. The secondary enclosure 50 telescopes in and out of the primary interior space 32, as is known to those skilled in the art. Thus, the secondary enclosure 50 is movable between a collapsed position, as is shown in FIGS. 1 and 2, and an expanded position, as is shown in FIG. 3. It will be appreciated that although the trailer assembly 10 is shown having two secondary enclosures 50 (one telescoping out from each of the pair of sidewalls 26, 28), the trailer assembly 10 may have only one secondary enclosure telescoping out from one of the pair of sidewalls 26, 28.

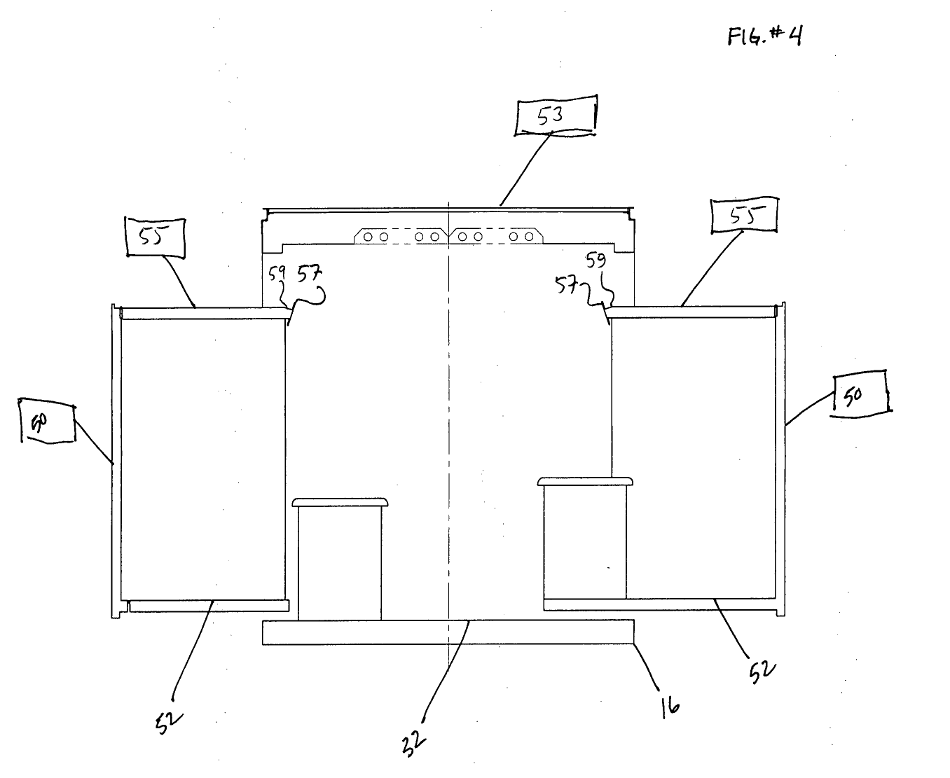

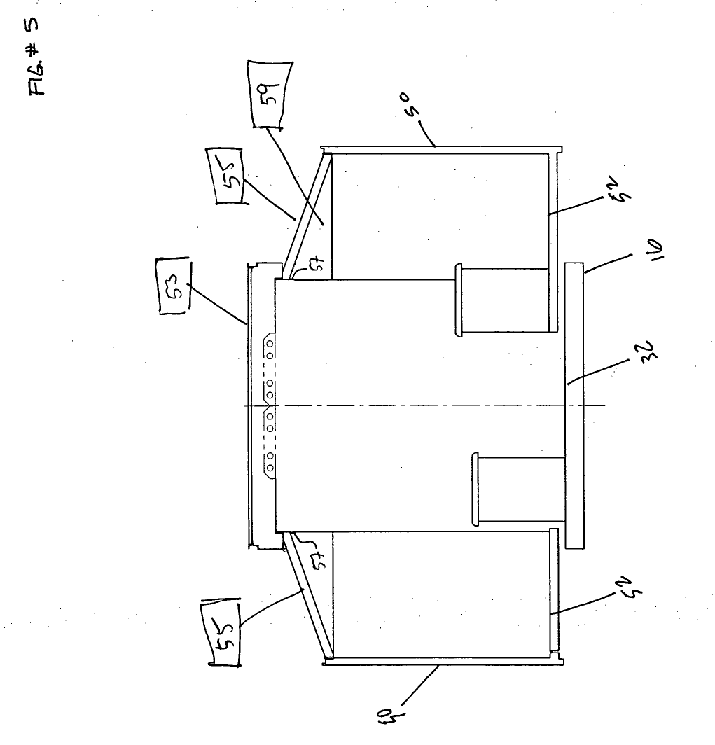

In addition, the roof 20 of the primary enclosure 18 includes a raisable roof portion 53. The raisable roof portion 53 is shown in the raised position in FIG. 4. Pivotal secondary roof portions 55 on either side of the raisable roof portion 53 pivot upwardly to seal the raisable roof portion 53 with the rest of the roof 20. Therefore, the secondary roof portions 55 have a pitch to them when they engage the raisable roof portion 53 in the raised position. The raisable roof portions 55 have a sealing flange 57 at a distal edge 59 thereof. In the embodiment shown, the distal edge extends through a curved path. Referring to FIG. 5, triangular expansion walls 59 complete the sidewalls of the secondary enclosures 50 when the raisable roof portion 53 is in the raised position.

When the secondary enclosure 50 is in the collapsed position, the trailer assembly 10 is capable of being stored efficiently. The trailer assembly 10 is also more transportable via the road system 14 when the secondary enclosure 50 is in the collapsed position. When the secondary enclosure 50 is in the expanded position, the total amount of space within the trailer assembly 10 is increased to accommodate various mobile work environments.

The axle/suspension carriage 44 includes a carriage platform 54 having a plurality of wheels 56 rotatably secured thereto for transporting the trailer assembly 10 via the road system 14. The axle/suspension carriage 44 is shown to have a single axle 58. It should be appreciated by those skilled in the art that although only a single axle is shown in FIGS. 1 through 3, the axle/suspension carriage 44 may have any number of sub-axles.

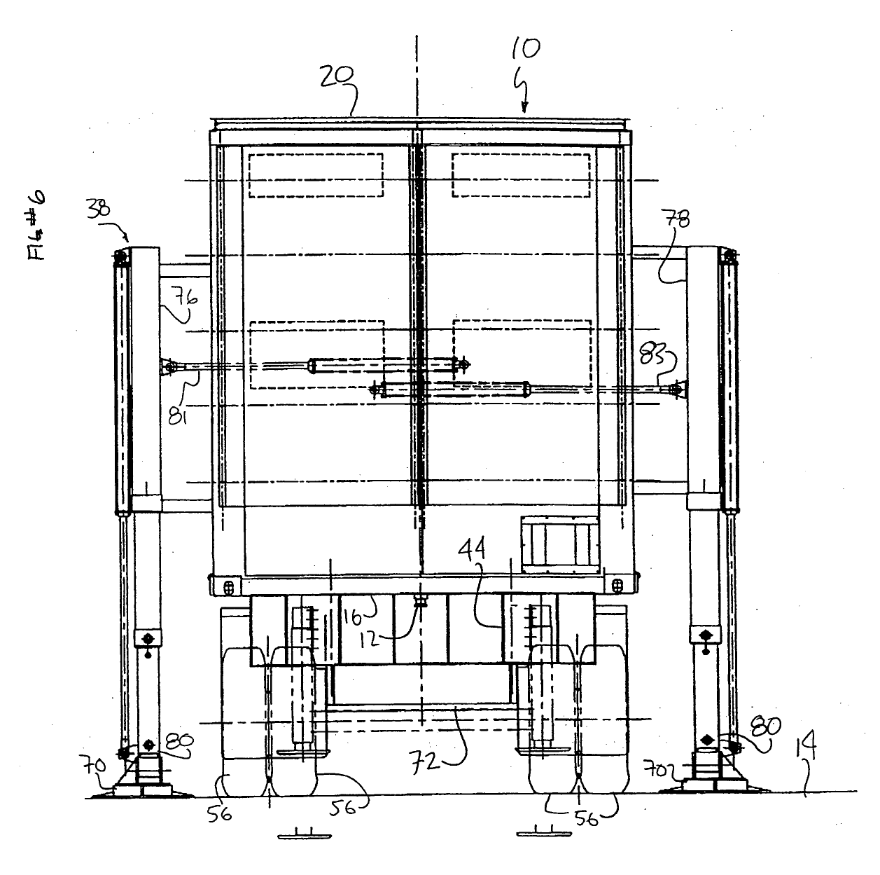

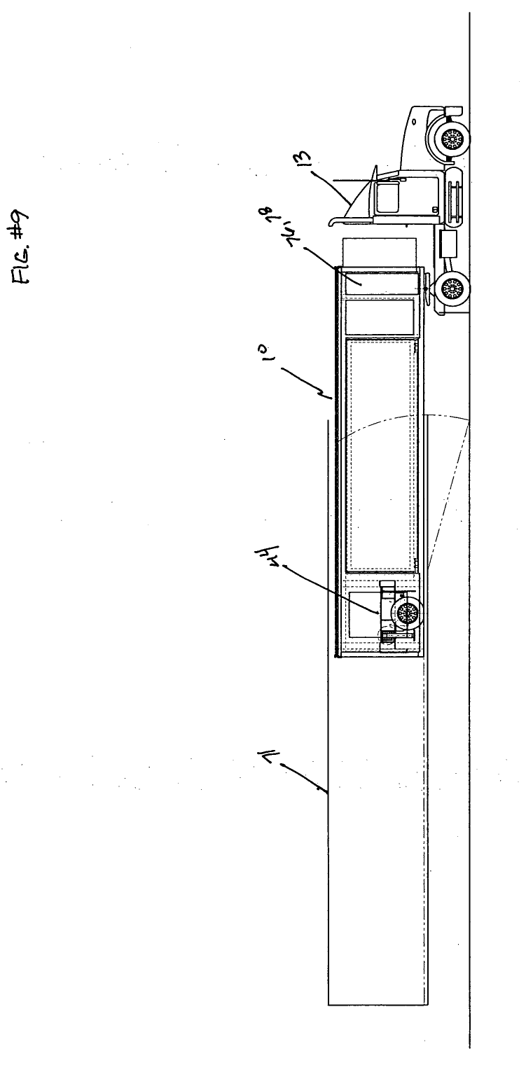

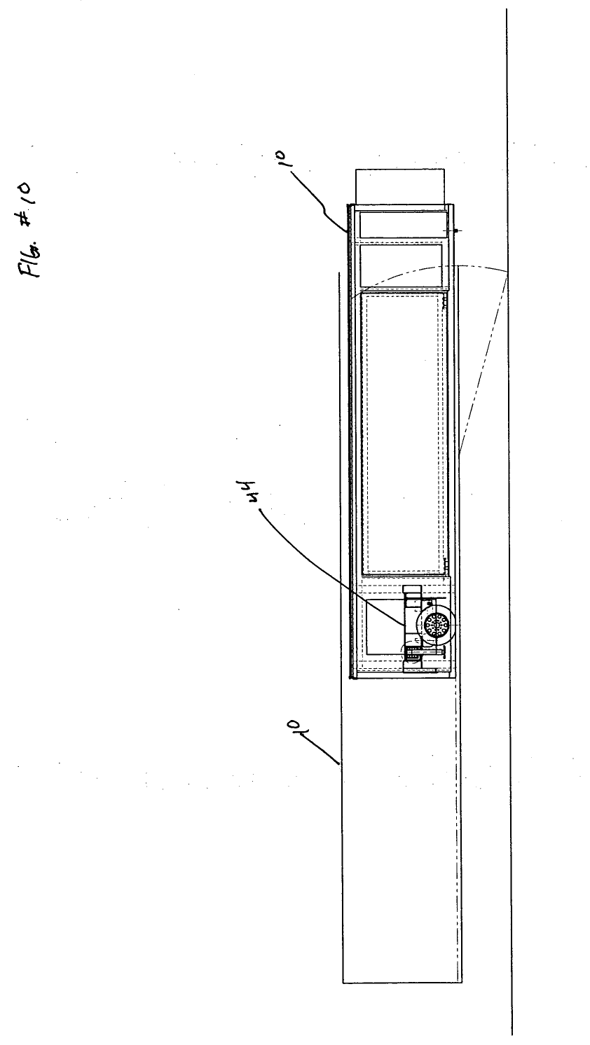

The axle/suspension carriage 44 is movable between an extended position (FIGS. 1 and 6) and a retracted position (FIGS. 2 and 8 through 11). A plurality of locking mechanisms 65 selectively retains the axle/suspension carriage 44 in the extended position or any of the plurality of supported positions.

When needed, the axle/suspension carriage 44 is moved along the plurality of vertically extending track members 62 between the extended and retracted positions. A hydraulic mechanism 86 may be used to raise and lower the trailer assembly 10 with respect to the axle/suspension carriage 44. It should be appreciated by those skilled in the art that mechanical and/or electrical systems might be incorporated as required by the capabilities of the trailer assembly 10 and the environments in which the trailer assembly 10 is going to be deployed.

Stands 68 provide a stable base when the axle/suspension carriage 44 is extended and the trailer assembly 10 is in a position of use. This lessens the load on the wheels in any given position over extended periods of time. The stands 68 are retracted when the trailer assembly 10 is moving or when the axle/suspension carriage 44 is in the retracted position.

When the axle/suspension carriage 44 is in the extended position, the trailer assembly 10 is in an elevated position due to the positioning of the plurality of wheels 56 substantially lower than the rearward compartment 42. The trailer assembly 10 can be coupled with a mode of transport via the king pin 12 to allow travel of the trailer assembly 10.

When the axle/suspension carriage 44 is in the retracted position, the trailer assembly 10 is in a lowered position due to the fact that a portion of the axle/suspension carriage 44 is located within the rearward compartment 42. This reduces the height of the trailer assembly 10, which in turn reduces the overall volume consumed thereby. Thus, when the axle/suspension carriage 44 is in the retracted position, the trailer assembly 10 is able to fit inside or on top of various modes of transport, one example being inside of a military transport aircraft 71. As a result, the trailer assembly 10 may be efficiently stowed and transported via rail, sea and/or air.

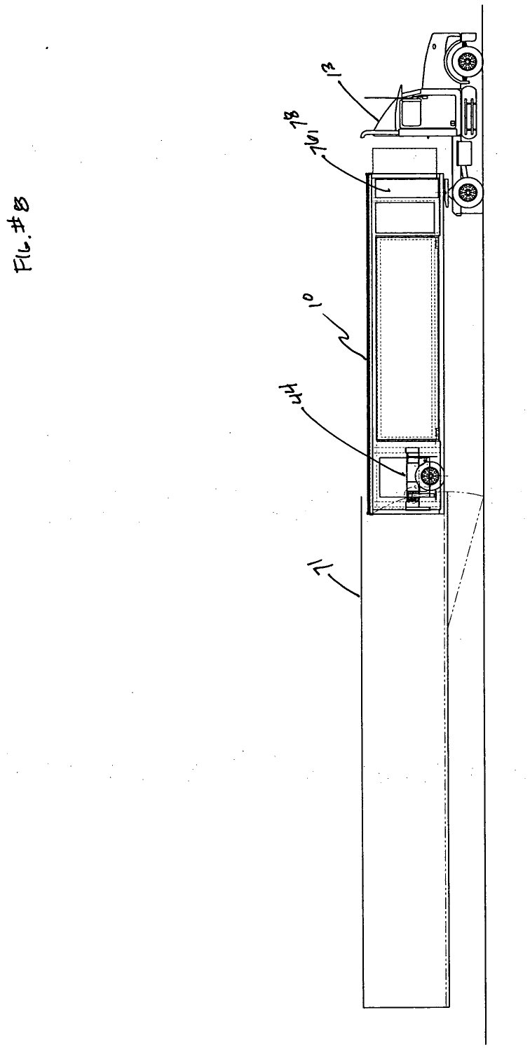

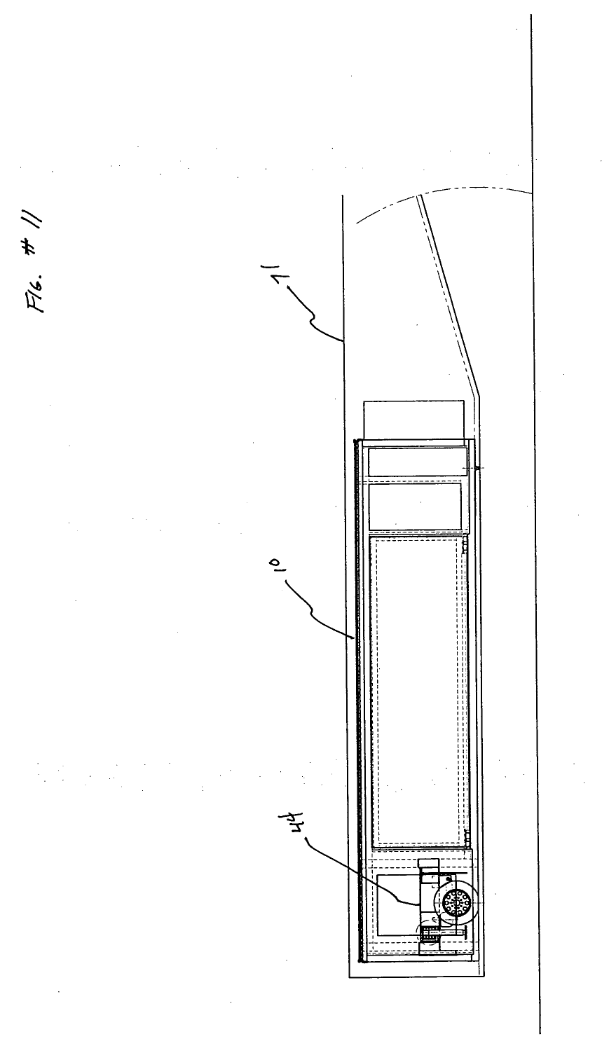

By way of example, FIGS. 8 through 11 show the trailer assembly 10 being stowed in the military transport aircraft 71. The back end of the trailer assembly 10 is lowered onto the floor 73 of military transport aircraft 71. The axle/suspension carriage 44 is lifted to its retracted position. Rollers (not shown) on the floor 73 allow the truck 13 the ability to move the trailer assembly 10 into the military transport aircraft 71. When the truck 13 can move no further back, the truck 13 disconnects the trailer assembly 10 therefrom. A wench (not shown), which is standard equipment on the military transport aircraft 71, is connected to a portion of the trailer assembly 10 near the rear wall 24. The wench pulls the trailer assembly 10 back into its storage position, as shown in FIG. 11, which shows the military transport airplane in its take-off condition.

The movement of the axle/suspension carriage 44 between its extended and retracted positions allows the trailer assembly 10 to be airlifted to a remote location and subsequently be moved away from the airport (or landing location) using the plurality of wheels 56 after they are moved to the extended position.

A rear bumper 72 is fixedly secured to the axle/suspension carriage 44. When the axle/suspension carriage 44 is in its extended position, the rear bumper 72 is in an operative position extending below the base 16 of the trailer assembly 10. When the axle/suspension carriage 44 is in its retracted position, the rear bumper 72 is located within the rearward compartment 42 so as not to interfere with stowage and transport of the trailer assembly 10 via rail and/or air.

Referring to FIG. 6, the forward stand assembly 38 holds the trailer assembly 10 level when the axle/suspension carriage 44 is deployed to its extended position. The forward stand assembly 38 can be moved in concert with the axle/suspension carriage 44 to prevent the base 16 from moving in a non-parallel manner with respect to the road system 14 below it. The forward stand assembly 38 telescopes between a stowed position, as shown in FIG. 2, and a support position, as shown in FIGS. 1 and 6. The forward stand assembly 38 also moves between an inward orientation and an outward orientation.

The forward stand assembly 38 is fixedly secured to the base 16 and includes a pair of support legs 76, 78, each terminating at a distal end 80 having a pad 70, preferably made of aluminum, secured thereto. When the forward stand assembly 38 is in the support position, each of the support legs 76, 78 is moved out and away from the forward compartment 36 using telescoping extensions 81, 83. The outward orientation of the support legs 76, 78 allows the support legs 76, 78 to extend to the support position to support the base 16 while simultaneously allowing the truck 13 access to the centrally located king pin 12. More specifically, the truck 13 is able to back up underneath the trailer assembly 10 and access the king pin 12 without interference from the forward stand assembly 38 when the forward stand assembly 38 is in the support position with an outward orientation.

In use, the trailer assembly 10 can be moved to a desired location by the mode of transportation, while the axle/suspension carriage 44 remains in the extended position, as shown in FIGS. 1 and 6. While moving the trailer assembly 10 to the desired position, the axle/suspension carriage 44 can be adjusted to and maintained in any of the plurality of supported positions between the extended and retracted positions to avoid obstacles.

When the trailer assembly 10 is in the desired location, the forward stand assembly 38 is extended outwardly to its outward orientation and downwardly to the support position, as best shown in FIG. 1. The support legs 76, 78 are moved outwardly relative to the forward compartment by the telescoping extensions 81, 83 to facilitate disconnection of the trailer assembly 10 from the mode of transport. After the mode of transport has been disconnected and removed from under the base 16, the trailer assembly 10 can be lowered to the storage position, as shown in FIG. 8, to minimize the profile of the trailer assembly 10 at the desired location. While the support legs 76, 78 retract, they maintain their outward orientation. The forward assembly 38 acts in unison with the axle/suspension carriage 44 to lower the trailer assembly 10 to its reduced profile position. Depending on what is stored in the trailer assembly 10, it may be important to be able to lower the trailer assembly 10 while maintaining it parallel to the ground. The above described operation is reversed to return the trailer assembly 10 from the storage position to the transport position, such that the king pin 12 is presented for re-attachment to the mode of transportation.

The forward stand assembly 38 and the axle/suspension carrier 44 can be operated cooperatively to move the trailer assembly 10 between the transport position and storage position or any position therebetween, while maintaining the trailer assembly 10 in any longitudinal orientation, such as parallel to the ground or horizontal. Control of the movements of the forward stand assembly 38 and the axle/suspension carrier 44 may be done manually or electronically using a control circuit designed to coordinate this reciprocating motion.

Because several powered components are secured to the carriage platform 54, a robotic track 88 is used to maintain an electrical connection between the primary enclosure 18, any computer workstations, the rearward compartment 42 and the nose box 46. The robotic track 88 includes a plurality of hinged components that allow each component to roll over the other to ensure the electrical connection is maintained. The robotic track 88 obviates the need for a soft wire harness.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A trailer assembly comprising:
a base extending between a front end and a back end;
a primary enclosure extending upwardly from said base and defining a primary interior space;
an axle/suspension carriage secured to said back end of said base; and
a forward stand assembly fixedly secured to said front end of said base, said forward stand assembly movable between a stowed position disposed adjacent said primary enclosure with said base positioned away from ground and a support position with said base disposed adjacent to ground and said forward stand assembly extending out and away from said primary enclosure.

2. A trailer assembly as set forth in claim 1 wherein said forward stand assembly includes a plurality of support legs movable between a retracted position and an extended position for lowering and raising said trailer assembly.

3. A trailer assembly as set forth in claim 2 wherein said forward stand assembly includes a plurality of telescoping extensions to move each of said plurality of support legs out and away from said primary enclosure.

4. A trailer assembly as set forth in claim 3 wherein is plurality of telescoping extensions extend out from said primary enclosure perpendicularly thereto.

5. A trailer assembly as set forth in claim 4 wherein each of said plurality of support legs defines a distal end.

6. A trailer assembly as set forth in claim 5 wherein each of said support legs includes a pad pivotally secured to each of said distal ends.

7. A method of moving a trailer assembly between a transport position coupled to a mode of transportation and a storage position, the trailer assembly including a base, an axle/suspension carriage, and a forward stand assembly operatively coupled with the base and movable between a stowed position and a support position, the method comprising the steps of:
transporting the trailer assembly to a desired location for storage with the axle/suspension carriage in the extended position; and
moving the forward stand assembly between the stowed and support positions when the trailer assembly is in the desired location, such that the trailer assembly moves between the transport and storage positions.

8. The method as set forth in claim 7 wherein the step of moving the trailer assembly to the desired location includes adjusting the forward stand assembly among a plurality of intermediate positions between the stowed and support positions to avoid interference with obstacles while transporting the trailer assembly to the desired location.

9. The method as set forth in claim 8 including the step of maintaining the forward stand assembly in the extended position prior to movement toward the retracted position to allow the trailer assembly to be disconnected from the mode of transportation.
